(19) United States
(12) Patent Application Publication
(10) Pub. No.: US 2006/0251755 A1
(43) Pub. Date: Nov. 9, 2006

(54) Apparatus for machining a formed thermoplastic plate

(76) Inventor: Manfred Geiss, Sesslach (DE)

Correspondence Address: JENKINS, WILSON, TAYLOR & HUNT, P. A., 3100 TOWER BLVD, SUITE 1200, DURHAM, NC, 27707, US

(21) Appl. No.: 11/409,688

(22) Filed: Apr. 24, 2006

(30) Foreign Application Priority Data
May 9, 2005 (DE) 102005022004.5

(51) Int. Cl. B29C 55/28

(52) U.S. Cl. 425/388

(57) ABSTRACT

An apparatus for machining a formed thermoplastic plate for detaching at least one molded part comprises a multi-axis machining device having at least one machining tool and a machining table for a formed thermoplastic plate. The formed thermoplastic plate comprises at least one molded part to be machined and the machining table comprises a suction device for securely receiving the formed thermoplastic plate and for simultaneously removing chips generated during machining of the thermoplastic plate.

### BACKGROUND OF THE INVENTION

1. Field of the Invention

The invention relates to an apparatus for machining a formed thermoplastic plate for detaching at least one molded part.

2. Description of the Related Art

Thermoforming machines or vacuum forming machines are commonly used for the fabrication of thermoplastic molded parts, in which a preferably rectangular thermoplastic plate is subjected to a deformation for the production of the molded parts. After leaving the vacuum forming machine a thermoplastic plate has then been obtained, which has at least one portion in which the molded part is formed, and this molded part then has to be removed, especially detached, in a subsequent machining step. To this end, a multi-axis machining device having at least one machining tool is commonly used, such as a three-axis milling machine.

In connection with the detachment of molded parts it is moreover known to apply a saw blade in a vertical spindle of the milling machine, so as to allow a trimming with as few burrs as possible. However, such milling machines require a special milling receptacle for each molded part, whereby each part to be milled has to be clamped correspondingly onto the respective milling receptacle for the machining. In addition, chips are produced during the milling, which may enter into the milling receptacle and negatively affect an exact machining of the molded part. If machining chips are to remain without any influence, they have to be removed in a separate step after each molded part machining operation, which delays the production of molded parts and makes it more expensive.

### SUMMARY OF THE INVENTION

It is an object of the present invention to provide an apparatus of the aforementioned kind, which allows a detachment and machining, respectively, of molded parts without special milling receptacles and without a time-consuming removal of chips after each machining operation.

The object is achieved in accordance with the invention by means of an apparatus for machining a formed thermoplastic plate for detaching at least one molded part, comprising a multi-axis machining device having at least one machining tool, and a machining table for the formed thermoplastic plate including at least one molded part to be machined. The machining table comprises a suction device for the secured reception of the formed thermoplastic plate and the simultaneous removal of chips arising.

Thus, the invention advantageously provides for an apparatus for machining a formed thermoplastic plate for detaching at least one molded part, comprising a multi-axis machining device having at least one machining tool and a machining table for the formed thermoplastic plate including at least one molded part to be machined, with the machining table comprising a suction device for the secured reception of the formed thermoplastic plate and the simultaneous removal of chips arising.

Thus, a suction device for chips is applied in the solution according to the invention, which simultaneously serves to secure the formed thermoplastic plate, and also individual molded parts, on the machining table. The suction device for chips thereby advantageously also assumes the function of the milling receptacle for each individual molded part which, for the machining thereof, is now supported only with its molded part edge and is safely retained by means of negative pressure.

In a favorable manner also an effective removal of the chips by means of suction is achieved at the same time, by which it is prevented that these are conveyed by the milling machine into the vacuum forming machine and/or affect the machining process in a manner influencing the exactness of the production.

Suction openings may be formed in the machining table, which are preferably formed as through holes, however, which may also be oblong holes or openings having an optional geometric form and extending through the table. Furthermore, the machining table may also have different openings arranged individually or/and in groups or/and in patterns.

The suction device provided for generating the retaining force and the chip-withdrawing effect may be disposed inside or outside the machining apparatus, e.g. in a portion of a feeding machine placed ahead thereof. According to a preferred embodiment of the inventive apparatus, the suction device is arranged underneath the machining table, which not only results in a compact construction of the total machining apparatus, but also in short and low-loss suction paths, wherein the arrangement is preferably such that the suction ratios or suction pressures, respectively, on the machining table are approximately uniform, if necessary with the exception of the marginal area. Since mainly larger surfaces of non-formed portions of the thermoplastic plate rest on the marginal area, a smaller suction pressure of the suction device may here be sufficient.

The apparatus may comprise a so-called holding or clamping frame for the loading of the lateral edges of the thermoplastic plate, which allows a centering of the molded parts and, if necessary, an additional retention. For feeding the machining table and for removing detached molded parts, the clamping frame can preferably be moved vertically from the machining table. The clamping frame is preferably adjustable with respect to its size and can therefore be adapted to different plate dimensions and/or centering conditions and/or holding requirements.

The clamping frame may be provided with a centering means for aligning the formed thermoplastic plate, which preferably comprises at least two receptacles for centering elements, preferably centering tapers, formed on the thermoplastic plate. Moreover, each receptacle may preferably have at least one portion for additionally securing the thermoplastic plate or at least one molded part, respectively, so as to allow for an additionally required holding power on the machining table.

In a restricted version of the inventive apparatus, the machining apparatus has at least one punching tool as machining tool for vertically detaching at least one molded part from the formed thermoplastic plate, while a saw blade is provided as machining tool for detaching at least one molded part from the formed thermoplastic plate in an approximately burr-free horizontal manner.

The inventive machining apparatus may be used as an individual machining station. In a restricted version of the inventive apparatus, the arrangement is such that the inventive apparatus is associated with a feeding machine by which formed thermoplastic plates can be transferred individually to the machining table, wherein the association is provided functionally or preferably with a connection of housings of the feeding machine and the machining apparatus and with an adjusted control of the preferred cycle-wise feeding and the detachment machining, with which formed thermoplastic plates are transferred to the machining table individually.

For the transfer of the formed thermoplastic plate to the machining table a transfer means may preferably be provided in the feeding device, which preferably comprises a transfer slider.

In a further restricted version of the inventive apparatus, it is provided that the inventive apparatus is connected functionally and by the housings via the feeding machine to a thermoforming machine to allow an automatic operation with a coordinated feeding and machining.

### DESCRIPTION OF THE DRAWINGS

FIG. 1 is a schematic side view of an exemplary embodiment of an inventive machining apparatus.

FIG. 2 is a top view of the machining apparatus of FIG. 1 without a milling spindle.

FIG. 3 is an assembly formed of an inventive machining apparatus, a feeding machine and a thermoforming machine constructed as a unit.

### DESCRIPTION OF THE PREFERRED EMBODIMENTS

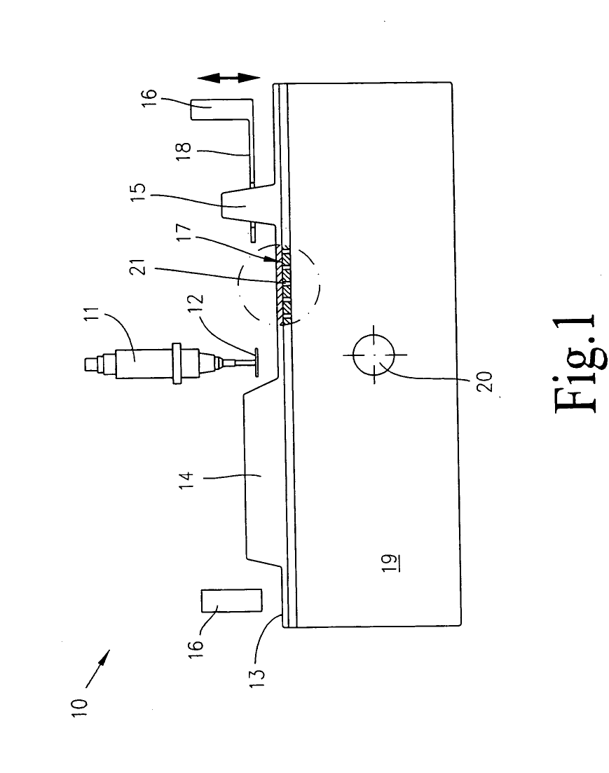

FIG. 1 schematically shows a side view of parts of the machining apparatus 10. For the purpose of facilitation only one milling spindle 11 with a saw blade 12 as tool of a multi-axis machining device is shown. A thermoplastic plate 13 is located underneath the milling spindle 11, in which a molded part 14 projecting upwardly from the plate 13 in FIG. 1 and produced by thermoforming, as well as a centering taper 15 are shown.

At the marginal sides the thermoplastic plate 13 can be fixed on a machining table 17 by means of a vertically movable clamping frame 16, wherein the clamping frame 16 has a centering means 18 with a receptacle for each centering taper 15, which is also provided for additionally retaining the thermoplastic plate or at least one molded part, respectively.

A laterally and downwardly closed housing 19 is disposed underneath the machining table 17, from the interior of which chips can be sucked off at 20 by a separate suction device. The non-illustrated suction device can alternatively also be arranged inside the housing 19.

The machining table 17 has through holes 21 on its top surface which, in the present embodiment, are formed as through bores and extend over the entire surface of the machining table in a uniformly distributed manner as to apply a suction pressure to the thermoplastic plate 13 lying on top thereof.

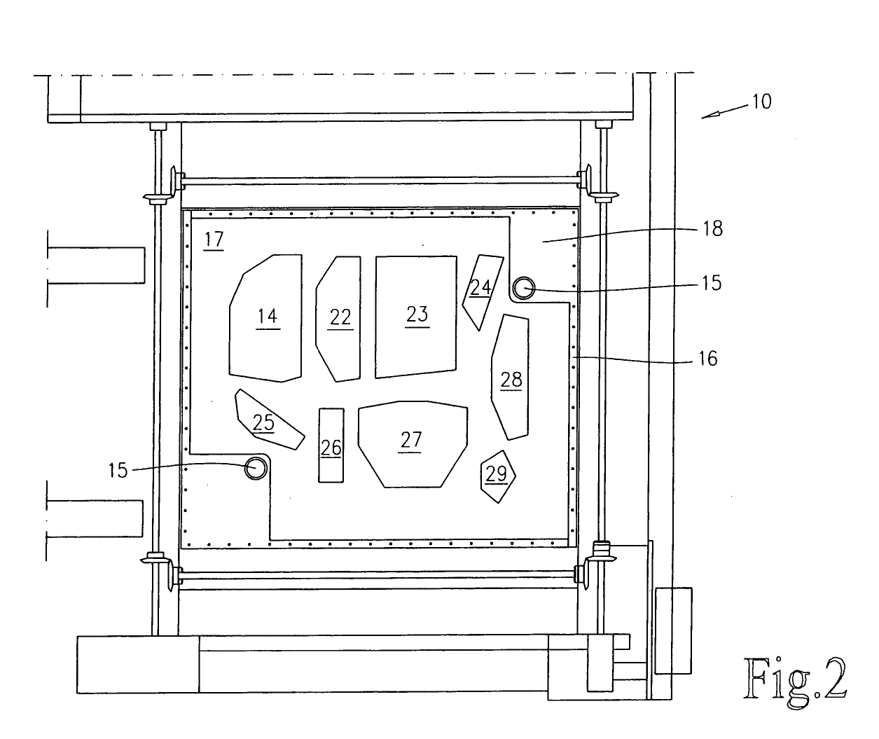

FIG. 2 shows a partially schematic view of the machining table 19 from above, wherein the spindle 11 and the machining tool 12 have been omitted and the thermoplastic plate 13 with the molded parts formed in the same is easy to recognize. Next to the molded part 14 also several other molded parts 22 to 29 are recognizable, which are designed differently.

It can moreover be seen in FIG. 2 that the clamping frame 16 can be adjusted with respect to its format. Moreover, device parts of the machining apparatus are outlined, which are provided for the control of the machining and for the connection to a feeding machine (FIG. 2, left).

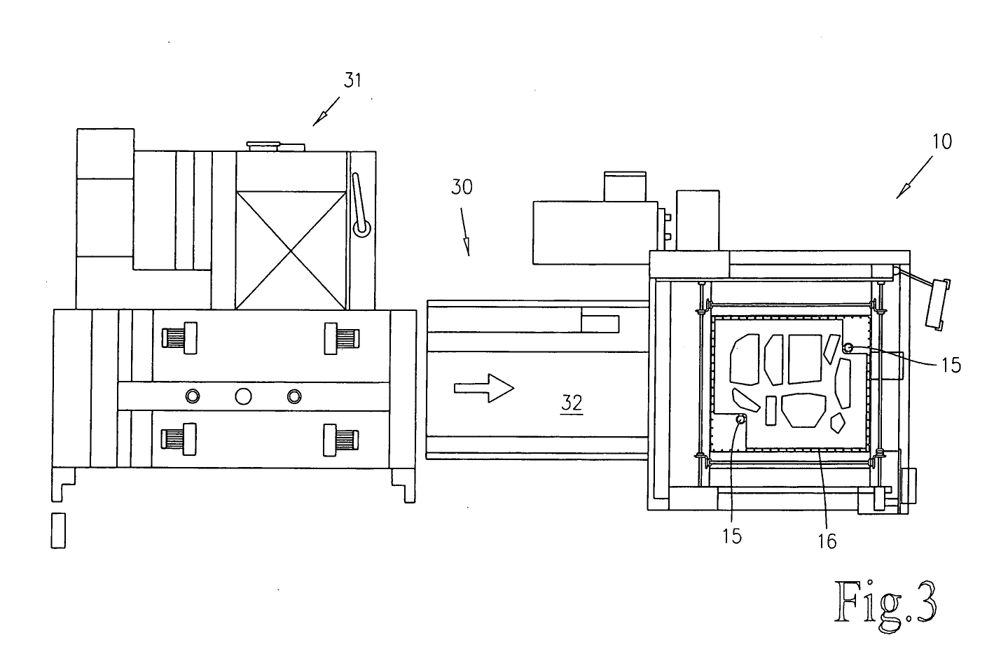

FIG. 3 shows a reduced illustration of the machining apparatus 10 constructively and functionally coupled to a feeding machine 30 and to a thermoforming machine 31. The arrangement is such that the housings of the machining apparatus, the feeding machine and the thermoforming machine are connected to each other in this order and cooperate cycle by cycle in correspondence with the production of the formed thermoplastic plates. A formed thermoplastic plate is removed from the thermoforming machine 31 by means of the feeding machine 30 and is transported by a slider 32 to the machining apparatus for detaching the molded parts 14, 22 to 29 formed in the formed thermoplastic plate 17.

Although modifications and changes may be suggested by those skilled in the art, it is the intention of the inventor to embody within the patent warranted hereon all changes and modifications as reasonably and properly come within the scope of his contribution to the art.

I claim as my invention:

1. An apparatus for machining a formed thermoplastic plate for detaching at least one molded part, comprising:
a multi-axis machining device having at least one machining tool; and
a machining table for a formed thermoplastic plate; said formed thermoplastic plate comprising at least one molded part to be machined and said machining table comprising a suction device for securely receiving said formed thermoplastic plate and for simultaneously removing chips generated during machining of said thermoplastic plate.

2. The apparatus of claim 1, wherein said machining table comprises suction openings.

3. The apparatus of claim 1, wherein said suction device is disposed underneath said machining table.

4. The apparatus of claim 1, comprising a clamping frame provided for lateral edges of said thermoplastic plate.

5. The apparatus of claim 4, wherein said clamping frame is adjustable with respect to its size.

6. The apparatus of claim 4, wherein said clamping frame is movable vertically from said machining table for feeding said machining table and for removing detached molded parts.

7. The apparatus of claim 4, wherein said clamping frame comprises a centering means for aligning said formed thermoplastic plate.

8. The apparatus of claim 7, wherein said centering means comprises at least two receptacles for centering elements formed on said thermoplastic plate.

9. The apparatus of claim 8, wherein each of said receptacles comprises at least one portion for additionally securing said thermoplastic plate or at least one of said molded parts.

10. The apparatus of claim 1, comprising at least one punching tool as said machining tool.

11. The apparatus of claim 1, comprising a saw blade as said machining tool for the approximately burr-free horizontal detachment of at least one of said molded parts from said formed thermoplastic plate.

12. The apparatus of claim 1, being associated with a feeding machine by which said formed thermoplastic plates are transferred individually to said machining table.

13. The apparatus of claim 12, wherein said feeding device comprises transfer means.

14. The apparatus of claim 13, wherein said transfer means comprise a transfer slider.

15. The apparatus of claim 12, being connected via said feeding machine to a thermoforming machine.
